(19) United States
(12) Patent Application Publication
(10) Pub. No.: US 2010/0161521 A1
(43) Pub. Date: Jun. 24, 2010

(54) Fund raising business method employing brand creation and food packaging advertising

(76) Inventor: Andrew L. Friend, Saugus, MA (US)

Correspondence Address: John M. Brandt, 60 Thaxter St., Hingham, MA, 02043, US

(21) Appl. No.: 12/653,051

(22) Filed: Dec. 8, 2009

Related U.S. Application Data
(60) Provisional application No. 61/201,298, filed on Dec. 8, 2008.

(51) Int. Cl. G06Q 90/00

(52) U.S. Cl. 705/500

(57) ABSTRACT

A fund raising business method engaged in on behalf of a donatable entity consisting of the creation of a brand name associated with the entity for food products; preparing the packaging and printing advertising to be included with the packaging of the food product; preparing a marketable product using the created brand name to include the packaging, the advertising, and the food product; distributing and selling the marketable product to the public; and donating a portion of the proceeds to the entity.

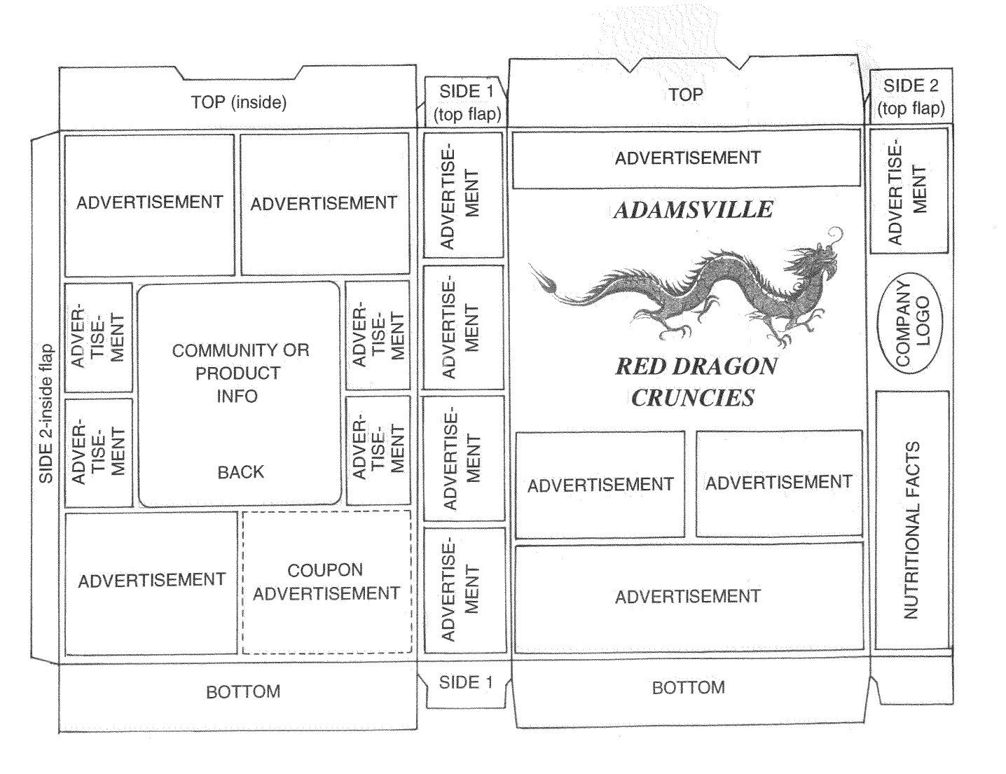

### CROSS REFERENCE TO RELATED APPLICATIONS

This application is based on Provisional Application Ser. No. 61/201,298 filed Dec. 8, 2008 by the same inventor.

### BACKGROUND OF THE INVENTION

1. Field of the Invention

The invention relates to business methods for fund raising for donatable entities.

2. Description of the Prior Art

The sale of food products by donatable entities to raise money for their operations and purposes is a well known practice. Such entities include a wide array of individuals and organizations, in particular, the general class of non-profits and more specifically charitable groups, public institutions, fraternal societies, special interest clubs and individuals conducting political campaigns.

Primary examples of such fund raising activities are the sale of cookies by the girl scouts and specially imprinted packaging for candy, fruit, coffee and other such food products sold by school organizations such as athletic teams, glee clubs, bands, and the like.

Businesses supplying these salable items on specific order are also well known. However, in the current practice, the entity itself must arrange for the purchase and sale of the products, requiring a substantial investment of upfront money and additional overhead expense.

Further, the carrying out of a fund raising drive based on this method ordinarily requires a large amount of effort. Financial success greatly depends on the involvement, dedication, and ability of committed volunteers which may vary from group to group and year to year. The selling of the product usually involves such activities as door-to-door solicitation, stand-outs at public places such as shopping malls, or the placement of attended sales tables on the interior of a highly frequented public building.

The business method of the present invention provides a significant improvement over the basic do-it-yourself concept described above by involving the expertise and financial resources of an external third party organization. Additional revenue and community interest are contributed by advertisers. Product placement in a wide variety of retail locations is possible. Integration with similar products, which shoppers are already seeking, is another feature along with the opportunity to provide funds on a continuing basis by product supply replenishment without the need to periodically reestablish a fund raising program.

The following summary of the invention outlines the steps that are involved in carrying out the method.

### SUMMARY OF THE INVENTION

The invention may be summarized as a fund raising business method for the benefit of a donatable entity consisting of the following combination of steps:

1. entering into an agreement with a selected entity to create a brand name associated with that entity for a food product, cereal for example, in exchange for an agreed upon donation benefit resulting from the distribution and sale of the product;

2. securing the agreement of one or more additional parties to advertise their products or services in a printed message to be included with the packaging of the food product, for example, on the outside of a cereal box;

3. preparing the packaging and imprinting the message and the brand name

4. combining the food product, the message, the brand name, and the packaging to provide a finished marketable product;

5. distributing and selling the marketable product to the public; and

6. forwarding the agreed upon donation benefit to the entity.

Each of the above steps will be discussed in further detail in the description of the preferred embodiment accompanied by the drawing below.

### DESCRIPTION OF THE DRAWING

The FIGURE is a plan view of a suitable food product package for use with the invention.

### DESCRIPTION OF THE PREFERRED EMBODIMENT

The method commences by contacting and presenting the plan as outlined above to likely client candidates who are able to accept and seek donations. A prime example are schools with extracurricular sports teams in need of funds to offset participation fees, procure equipment, and provide transportation to athletic events. The required participation is only that they lend their name to the fund raising program in return for an agreed upon donation. A brand and food product is chosen, ADAMSVILLE RED DRAGON CRUNCHIES for cereal for a sports team as an example. This creates an immediate expectation of a clientele for the product, as it will become known in the community through word of mouth and publicity efforts that purchase of the cereal will benefit the team.

Advertising agreements are then solicited and procured by any number of means such as blind calls, leads provided by the client, and perusal of class yearbooks and event programs which include advertising. This creates an additional revenue stream as well as raising community interest in the project. Local businesses are considered the major source for such ads because of their connection with the community and their desire to support the local teams. However, nothing prevents these ads from being obtained from anyone having a wider reach than the immediate geographical area.

Once the advertising agreements are completed, the packaging is prepared by selecting a packaging style and creating the graphic design for the printing of the advertising and brand name to be included with the packaging. The FIGURE illustrates an example of a layout for a cereal box using the brand name selected above. Cereal as a subject food product has been found to be particularly effective for the advertising component of this method since it is something that almost everybody eats, is used repeatedly before the contents are exhausted, and often remains in plain view in a household for an extended period of time. Cereal is also sold in a variety of stores such as supermarkets, convenience stores, and drug stores, and may also appear on the breakfast menu of local restaurants and school cafeterias.

Other food products may be used as well with appropriate packaging. Fruit is an example, packed in small crates with the brand name label and an accompanying flyer or program book of advertising.

Combining the elements, brand name, advertising, food product, and packaging, is the next step and may often be accomplished along with the printing by a subcontractor in the business of preparing private brand merchandise to order.

Once the final marketable product is in hand, the next step is to distribute and sell the items to the public. Most likely, there will have been prior arrangements made for this with local stores. The normal fund raising channels for sales by the entity are also available, but only if they so desire. Examples are those described above, standouts, door-to-door solicitation, and sales at events in which the entity engages, for instance, athletic contests using the sport team model.

The donation may be made using any agreed upon formula, for example, from a fixed amount to a percentage of sales, to further compensation in exchange for participation by the entity.

As variations in the above-described embodiments will now be obvious to those skilled in the art, the invention is accordingly defined by the following claims.

What is claimed is:

1. A fund raising business method for donatable entities comprising in combination the steps of:
A. securing the agreement of a selected entity to create a brand name associated with said entity for a food product in exchange for an agreed upon donation benefit resulting from the distribution and sale of said product;
B. securing the agreement of at least one additional party other than said entity to subscribe to a printed advertising message to be included with the packaging of said food product;
C. preparing said packaging and imprinting said message and said brand name;
D. combining said food product, said printed message, said brand name, and said packaging to provide a finished marketable product;
E. distributing and selling said marketable product to the public; and
F. forwarding said agreed upon donation benefit to said entity.
